(19) United States
(12) Patent Application Publication
(10) Pub. No.: US 2022/0036137 A1
(43) Pub. Date: Feb. 3, 2022

(54) METHOD FOR DETECTING ANOMALIES IN A DATA SET

(71) Applicant: Rulex, Inc., Newton, MA (US)

(72) Inventors: Marco Muselli, Genoa (IT); Massimiliano Costacurta, Genoa (IT); Damiano Verda, Genoa (IT); Enrico Ferrari, Genoa (IT)

(21) Appl. No.: 17/275,981

(22) PCT Filed: Sep. 19, 2018
(86) PCT No.: PCT/US2018/051694

§ 371 Date: Mar. 12, 2021

(51) Int. Cl. G06K 9/62; G06N 20/00

(52) U.S. Cl. CPC G06K 9/6263; G06K 9/6259; G06K 9/6202; G06N 20/00; G06K 9/6277; G06K 9/628; G06K 9/6218

(57) ABSTRACT

A computer-implemented method and system for detecting anomalies in an unlabeled data set of data records is provided. The method applies a classification method to a training data set obtained from the unlabeled data set to generate a classification model associating a predicted output class to each training data record. The predicted output class is compared with the original output class, in order to detect an anomalous data record in the presence of a discrepancy between the original and the predicted output class. The method may assign a confidence score to the predicted output class by the classification model, wherein the anomalous data record is detected on the basis of a threshold of the confidence score. For example, the classification method may be based on Boolean functions synthesis by a Shadow Clustering algorithm, and the classification model is in the form of a set of conditional rules.

### BACKGROUND

In data mining, anomaly detection is the identification of items, events or observations which do not fulfill the most frequent patterns in a dataset. Anomaly detection is applicable in a variety of domains, such as intrusion detection, fraud detection, fault detection, system health monitoring, event detection in sensor networks, and detecting ecosystem disturbances. It is often used in preprocessing to remove anomalous data from a dataset.

A review on anomaly detection may be found in Chandola, V., Banerjee, A., and Kumar. V. 2009. Anomaly detection: A survey. ACM Comput. Surv. 41, 3, Article 15 (July 2009).

Main methods for detecting anomalies in a data set are unsupervised or supervised methods, depending if they operate on an unlabeled or labeled data set. In a labeled data set, the labels associated with a data record denote whether that data record is normal or anomalous. In an unlabeled data set, no information on the behavior of a data record are available. It should be noted that obtaining labeled data that is accurate as well as representative of all types of behaviors, is often prohibitively expensive. Labeling is often done manually by a human expert and hence substantial effort is required to obtain the labeled training data set. Typically, getting a labeled set of anomalous data instances that covers all possible types of anomalous behavior is more difficult than getting labels for normal behavior.

Unsupervised anomaly detection techniques detect anomalies in an unlabeled data set. Unsupervised anomaly detection is based on the assumption that the majority of the instances in the data set are normal by looking for instances that seem to fit least to the remainder of the data set. Two main approaches are known: statistical approach and clustering. In statistical approach, anomalies are identified on the basis of a deviation from common statistical properties of a distribution, including mean, median, mode, and quantiles. For instance, an anomalous data point is one that deviates by a certain standard deviation from the mean. In clustering techniques, data records are grouped together in such a way that data records in the same group (called a cluster) are more similar (in some sense) to each other than to those in other groups (clusters). Data records that are close to each other according to a suitable definition of distance (measure) form a cluster and are considered normal. Isolated data records that are far from a cluster are considered anomalies.

One disadvantage of unsupervised anomaly detection techniques is that, while they are able to identify anomalies, they do not provide results in an intelligible form which may be easily understood and analyzed. In other words, unsupervised anomaly detection techniques detect an anomalous data record, but they do not explain why it is anomalous. Therefore, no support for validating the anomalous data record is received, as well as for deciding whether the data record is effectively anomalous.

Supervised anomaly detection is based on the availability of a labeled data set. A typical approach in such cases is to build a predictive model from the labeled data set, for associating any further data record not comprised in the training data record to a normal or anomaly class. Any further data record is therefore compared against the model to determine which class it belongs to and to detect if it has a normal or an anomalous behavior. Typically, the predictive model is a classification model generated by applying a classification method to the training data set. Classification is used to learn a model (classifier) from a set of labeled data (training data set) and then to classify a test data record into one of the classes using the learned model (testing).

Classification-based anomaly detection techniques operate in a similar two-phase step. The training phase learns a classifier using the available labeled data set as training data set. The testing phase classifies a test data record as normal or anomalous, using the classifier. Among classification methods, methods based on decision trees, neural networks and Support Vector Machines may be used. One drawback of supervised anomaly detection is that the labeled data set is assumed to be correct. Any anomalous data record in the labeled data set which is used as training data set may affect the classification model. Therefore, the classification model may be inaccurate. On the other hand, the classification model may be in an intelligible form.

### BRIEF DESCRIPTION OF THE INVENTION

Insofar, classification methods have not been applied to successfully detect anomalies in an unlabeled data set. There is the need for a method of detecting anomalies in an unlabeled data set and providing results in an intelligible form for a human supervisor, thereby providing the anomalous data records and a model for interpreting the reasons why the data record is considered anomalous. More information for validating the anomalous data records may be generated.

The present specification relates to a computer-implemented method and system based on a classification approach for detecting anomalies in an unlabeled data set.

It is disclosed a computer-implemented method for detecting anomalies in an unlabeled data set comprising data records of independent variables and at least one variable which is known to depend on one or more of the independent ones. The independent variables will be referred to as inputs and the dependent one will be referred to as output. The method comprises a step of generating from the unlabeled data set, by a computing device, a training data set comprising training data records and original output classes. Each training data record is obtained by excluding from a corresponding data record at least the output variable; an original output class corresponding to the value of the corresponding output variable of the data record is associated to the training data record. Said method further comprises a step of applying, by the computing device, a classification method to the training data set, to generate a classification model associating to each training data record a predicted output class selected from a set of original output classes associated to the training data records. The method further comprises a step of comparing, by the computing device, the original output class and the predicted output class, in order to detect an anomalous data record in the presence of a discrepancy between the original and the predicted output class.

The computer-implemented method may further comprise a step of assigning a confidence score to the predicted output class by the classification model, and that the anomalous data record is detected based on a threshold of the confidence score.

The predicted output class may be the output class which optimizes a probability score assigned to each output class by the classification model.

The confidence score of the predicted output class may be assigned based on the probability scores associated to the output classes.

The anomalous data record may be submitted to a validation step to generate a corrected data set.

The classification model may be in the form of a set of conditional rules of input variables.

The classification method may be based on Boolean functions synthesis, wherein that said method may comprise: a step of converting the training data records into binary strings of a Boolean space by a coding that preserves ordering and distance; a step of generating at least one cluster of binary strings, the cluster comprising binary strings covered by an implicant, wherein the corresponding training data records are associated to the same output class; a step of generating a conditional rule from the implicant.

The implicant may be generated by a Shadow Clustering algorithm.

The coding may be the inverse only-one coding.

The method may comprise a step of assigning one or more significance parameters to each conditional rule, wherein the probability scores may be assigned based on the significance parameters of the rules satisfied by the training data record.

The validation step may be performed by or under the supervision of a human operator on the basis of the conditional rules verified by the anomalous data record based on the conditional rules verified by the anomalous data record.

The input variables may be related to at least one category selected from the group comprising names, codes, time values, address components, control parameters, and numeric values.

The data records of the unlabeled data set may be related to an application selected from the group comprising: auto insurance damage claims, a business process, a medical patient records, a purchase order, and a supply chain management.

The method may be integrated in a business or operations software application selected from the group comprising: enterprise resource planning (ERP), customer relationship management (CRM), product lifecycle management (PLM), and electronic health records management (EHRM).

It is also disclosed an apparatus comprising a processor and memory storing computer-executable instructions that, when executed by the processor, cause the apparatus to:
from an unlabeled data set comprising data records of input variables and at least one output variable dependent from one or more input variables, generate a training data set comprising training data records and original output classes, wherein:
each training data record is obtained by excluding from a corresponding data record at least the output variable, and
an original output class corresponding to a value of the output variable of the corresponding data record is associated to the training data record;
apply a classification method to the training data set, to generate a classification model associating a predicted output class to the training data record, wherein the predicted output class is selected from the original output classes associated to the training data records; and
compare the original output class and the predicted output class, wherein an anomalous data record is detected in a presence of a discrepancy between the original output class and the predicted output class.

The computer-readable instructions, when executed by the processor, may further cause the apparatus to assign a confidence score to the predicted output class by the classification model, wherein the anomalous data record is detected based on a threshold of the confidence score.

The predicted output class is the output class which optimizes a probability score assigned to each output class by the classification model.

The confidence score of the predicted output class is assigned based on the probability scores associated to the output classes.

The computer-readable instructions, when executed by the apparatus, cause the apparatus to:

submit the anomalous data record to a validation step, to generate a corrected data set.

The classification model may be in a form of a set of conditional rules of input variables.

### BRIEF DESCRIPTION OF DRAWINGS

FIG. 1 shows a block diagram of an apparatus configured to detect anomalies in an unlabeled data set in accordance with aspects of the subject matter described herein.

FIG. 2 shows a block diagram of an embodiment of the disclosed method.

FIG. 3 shows a block diagram of another embodiment of the disclosed method, wherein a classification method based on Boolean function synthesis is used.

FIG. 4 shows a block diagram of a further embodiment of the disclosed method, wherein a classification method based on a Support Vector Machine is used.

FIG. 5 shows a block diagram of another embodiment of the disclosed method, wherein a classification method based on a neural network is used.

### DETAILED DESCRIPTION

Examples described herein relate to methods and system for detecting anomalies in a data set.

The data set is a structured collection of data organized in data records. The data of the data record correspond to values assumed by a set of variables. The variables may be ordered variables and nominal (or categorical) variables. A variable xⱼ is ordered when xⱼ varies within an interval Bⱼ of the real axis and an ordering relationship exists between its values. A variable xⱼ is nominal when the set A, of values assumed by xⱼ have no natural ordering, e.g. the employment of a customer or the ZIP code. The data records may have the same number of data, e.g., they have the same length. In the case a data record has a shorter length with respect to the length of the other data record. e.g., a value of a certain variable is missing, the value that variable may be set to a reference value, for instance may be set to 0, or may be given the categorical attribute “Not Available”.

The disclosed method places no restrictions on the type of variables. For example, they may represent names, codes, time values, address components, control parameters, or numeric values.

In an embodiment, the data records in the unlabeled data set contain information related to a business process, such as a work order. The data records may be related to at least one category selected from the group consisting of product names, minimum quantities, lead times, and shipping methods.

In another embodiment, the data records in the unlabeled data set contain information related to medical patient records. The data records may be related to at least one category selected from the group consisting of standard codes for clinical diagnoses, prescribed treatments and medications, and medical equipment and supplies used.

In a further embodiment, the data records in the unlabeled data set contain information related to auto insurance damage claims. The data records may be related to at least one category selected from the group consisting of vehicle make and model, accident location and time, damage class, payment limit, and preferred repair provider.

Examples described herein have the advantage of detecting anomalies in parameters related to a real time or nearly real time production or logistic process with no or minimal supervision of a human operator, therefore reducing the risk that an entire batch of production is rejected.

The data set used herein may comprise an unlabeled data set, therefore it is not known whether a data record is normal or an anomalous. What is known is that the value assumed by at least one variable, known as output variable, is dependent from the value assumed by one or more other variables, indicated as input variables. Thereby, the value of the output variable in a data record is determined according to the value assumed by one or more other variables. In the unlabeled data set, there is a knowledge of which variable is a dependent variable. The output variable may not depend from all the input variables, but only from one or some of the input variables. It is not required that it is known the specific input variable or variables from which the output variable depends. Moreover, an input variable may further depend from one or more other variables.

Therefore, in the disclosed method it is known that at least one variable is an output variable. In the case that there is more than one output variables, the disclosed method may be applied to each output variable independently.

According to one aspect described herein, the disclosed method is an unsupervised method for detecting anomalies in an unlabeled data set, by which it is meant the identification of anomalous data records of the unlabeled data set, characterized by having a value of an output variable which does not conform to an expected value, as deduced from the whole unlabeled data set. An anomaly in the data set may be originated by different causes. For instance, when the value of the output variable is the result of a measurement of a physical entity, it may be due to a statistical error or to noise source affecting the measurement. In other cases, the anomaly may be due to a mistake in handling the data. In a further case, the value of the output variable may be correct, but an anomaly may be originated by some variation in the system underlying the data set.

In an example, the disclosed method may comprise a computer-implemented method, thereby it is carried out by or on a computer or other electronic apparatus capable of performing the prescribed method step on the unlabeled data set with no or minimal intervention of a human operator. Therefore, also disclosed is a program comprising instructions which, when the program is executed by the computer, cause the computer to carry out the disclosed method.

The disclosed method or the related computer program may be integrated in business or operations software applications used by management or operational personnel in an enterprise or organization to collect, store, manage, reference, and work process information, such as those for enterprise resource planning (ERP), customer relationship management (CRM), product lifecycle management (PLM), and electronic health records management (EHRM).

Thereby, according to another aspect described herein, it is disclosed a computer-implemented method which is particularly suitable for automatic data check of a very large amount of data, being capable of processing unlabeled data sets comprising many thousands of data records, or even more, in a short time (e.g., of the order of minutes). This feature may be useful, for example, when the data to be checked are relative to parameters of a continuously running process, such as a production process, which may require continuous monitoring and/or real-time intervention. Furthermore, the data records may comprise a large number of data, for example the data record may comprise many hundreds of data, or even more.

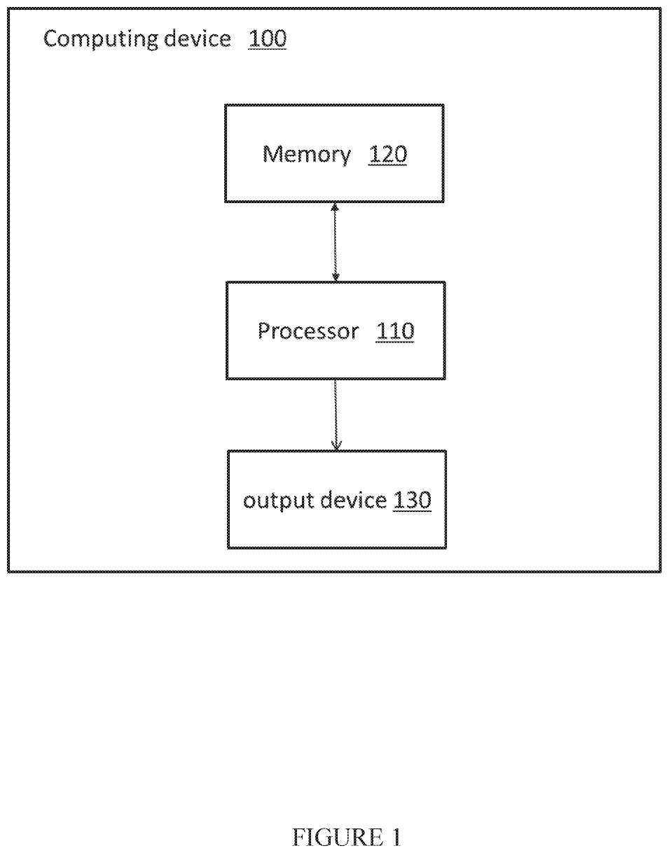

FIG. 1 depicts an apparatus 100, configured for detecting anomalies in an unlabeled data set in accordance with aspects of the subject matter described herein. The apparatus 100 comprises a processor 110 and a memory 120. The memory 120 may comprise random access memory (RAM), read-only memory (ROM), one or more hard drives, and/or any other type of computer-readable medium or memory. All or portions of apparatus 100 may reside on one or more computers or computing devices. Apparatus 100 or portions thereof may be provided as a stand-alone system or as a plug-in or add-in.

Apparatus 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

The memory 120 stores computer-executable instructions which are executed by the processor in order to can-y out the disclosed method. The memory 120 may further store process data, such as the unlabeled data set, the training data set, and/or data output. Alternatively, a separate memory, not shown in the figure, may be used for storing process data. The memory 120 and the processor 110 may be in communication for data exchange in both directions. The apparatus 100 may further comprise one or more output devices 130 for outputting process output data. In an embodiment, process output data may be in electronic form, such as an electronic file, and output device 130 may interface with another computing device, not shown in the figure, which receives the output data for further processing. For example, the output device 130 may comprise a network interface to communicate with other devices, such as via an external network. The external network may comprise a wired network, a wireless network, and/or a combination thereof. In another embodiment, output device 130 may comprise a display for displaying output data, such as a computer monitor.

Output data may comprise anomalous data records or a reference thereto, input variables identified as anomalous within an anomalous data record, corrected data records, parameters related to the confidence of the proposed correction, such as the confidence score, as well as an explanation on the proposed correction. The disclosed method to detect anomalies in an unlabeled data set is based on a new approach of implementing a classification method. In a general classification method, a learning machine is trained on a first data set, called a training data set, comprising training data records, wherein each data record is associated to a corresponding output class. On the basis of the examples of the training data set, the classification method generates a classification model to predict or verify the output class associated to a further data record or to a second data set of data records which are not included in the training data set. In the prior art classification approach, the training data set is assumed as correct, and the classification method is used to detect anomalies in data records other than those of the training data set, wherein the anomaly corresponds to an output class different from the output class predicted by the classification model. Moreover, an anomaly in the training data set, for instance corresponding to an erroneous output class associated to a training data record, may propagate to the classification model, thereby generating a wrong or inaccurate classification model.

Contrary to the approach of the prior art, in aspects described herein, a classification method is used to generate a classification model from a training data set, and the classification model is then used to detect anomalies in the data records of the same training data set. As a result, the corresponding original data record is detected as anomalous.

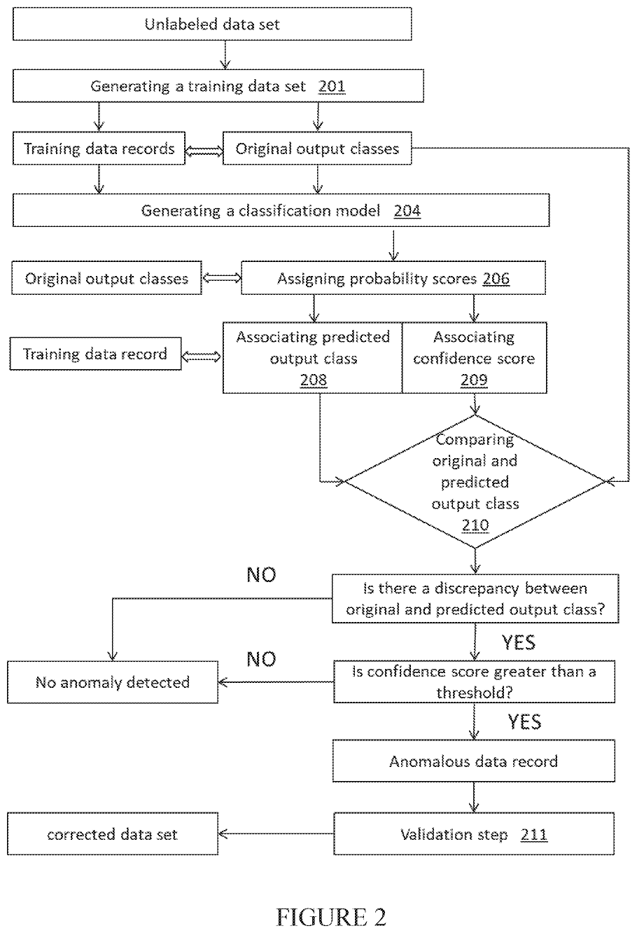

As represented in FIG. 2, the first step 201 of the disclosed method is to generate a training data set from the unlabeled data set. Thereby, according to another aspect described herein, it is provided a method to solve a data mining problem by a classification approach.

The training data set comprises training data records, wherein each training data record is obtained from a corresponding original data record of the unlabeled data set by excluding from the original data record at least the output variable. In other words, the training data records may comprise a portion of the corresponding original date records, wherein the portion does not include the output variable. In an embodiment, the training data record comprises all the data of the corresponding data record with the exception of the output variable. Therefore, the training data set may comprise all the input variables. Then an original output class which corresponds to the value of the output variable of the data record is associated to each training data record. The output class may be coincident to the value of the output variable of the corresponding unlabeled data record, for instance an unlabeled data record having an output variable assuming the nominal value “good” may be associated to the corresponding output class “good”. In other cases, the values of the output variable may be discretized in output class, thereby two unlabeled data records with output variables assuming values within a certain discretization interval may correspond to the same output class. For instance, in the case of an ordered output variable xⱼ∈R, two unlabeled data records with output variables assuming the values greater than 1 and lower than 2 may be associated to the output class 1-2.

It is understood that the generation of the training data set from original data set may not give raise to a data set distinct from the unlabeled data set, but it is sufficient that the input and output variables of the unlabeled data records are treated as components of the corresponding training data record and output class as provided by the disclosed method.

As represented in FIG. 2, the second step 204 of the disclosed method is to generate a classification model from the training data set and the original output classes. In principle, any classification method generating a classification model may be used in the aspects described herein, provided that the classification model associates to the training data record an output class selected from the set of output classes associated to the training data records. For instance, if each training data record is associated to an output class of the set of output classes comprising [1, 2, 4, 5], the classification model might not associate a data record to the output class [3], as this value is not present in the output classes.

In one embodiment, the classification method generates the classification model in the form of a black box. In other words, the model is constituted by algebraic functions which allow to get a prediction of the output class. This shows what is predicted but does not enable a human expert to understand and interpret why it is predicted. Among black box classification techniques, neural networks or Support Vector Machine (SVM) techniques may be used.

In another embodiment, the classification method is a rule generation method generating a classification model in the form of one or more conditional rules of the type:

if {conditions} then {output class},
wherein:
{conditions} indicates a condition on one or more input variables or a
set of conditions on one or more input variables of a data record linked by
a logical operator, and {output class} indicates an output class associated
to the data record.

The logical operators linking different conditions may be AND and/or OR.

In one embodiment, <conditions> is the logical product (AND) of mₖ conditions cₖₗ, with l=1, . . . , mₖ, on the components xⱼ, whereas <consequence> gives a class assignment y=\tilde{y} for the output. In general, according to the type of the variable xⱼ a condition cₖₗ in the premise of the rule has one of the following forms:
a threshold condition xⱼ>λ, xⱼ≤μ, or λ≤xⱼ≤μ, where λ and μ are two values in the domain Bⱼ of xⱼ, if xⱼ is an ordered variable.
a membership condition xⱼ∈A, where A is a non-empty subset of the domain Bⱼ, if xⱼ is a nominal variable.

One of the advantages offered by a rule generation method is that the logical rules may be understood and interpreted by a human expert. In one embodiment, the rule generation method is based on decision trees techniques. In an embodiment, the rule generation method is based on a shadow clustering method.

Illustrative classification methods and their implementation are described in the following of the present specification.

According to aspects described herein, the classification model associates a predicted output class to each training data record of the training data set in step 208 and the predicted output class is compared with the original output class in step 210, as represented in FIG. 2; in the case of a discrepancy between the predicted output class and the original output class, an anomaly is detected, and the corresponding data record of the unlabeled data set is considered an anomalous data record. A discrepancy means that the original output class is different from the predicted output class.

Once an anomaly has been detected, the anomalous data record may be then submitted to a validation step 211. The validation step 211 may confirm the original data record, or it may correct the original data record with the predicted output class, or the original data record may be rejected and excluded from the original data set. In one embodiment, the validation step 211 may be implemented by computer, in which case an automatic data correction is carried out on the basis of a criterion that takes into account the predicted output class and eventually the parameters characterizing the reliability of the prediction. In another embodiment, the validation step 211 is carried out by submitting the anomalous data records to a human expert, or operator. The manual validation step 211 may be used in the case of a classification method generating intelligible rules, specifically in the case of Shadow Clustering method, wherein the human expert may take advantage also from the interpretation of the conditional rules verified by the anomalous data record. The validation step 211 is performed only on the anomalous data records, which typically are a few cases, therefore the supervision or intervention of the human operator is needed only for a limited time and it has the advantage of taking into account the knowledge and experience acquired on the system underlying the data set. In the case of a validation step 211 requiring a human action, the threshold parameter of the confidence score may be fixed so that the anomalies detected do not exceed a certain amount, or a certain frequency. In this way, the human expert is required to address only the most critical cases.

As a result of the validation step 211, a corrected data set may be generated. The corrected data set may then be processed to detect further anomalies and the method may be reiterated until no more corrections are detected. Therefore, in the first reiteration, a first classification model is generated by applying the classification method to a first training data set generated from the unlabeled data set, and, in the case that at least a first anomalous data record is detected on the basis of the prediction of the first classification model according to the disclosed method, the first anomalous data record may be validated in a first validation step. In the case that no anomalies are detected, or that an anomaly is detected but the original data record is confirmed in first validation step, the original unlabeled data set does not comprise anomalies and therefore the whole data set is validated. In the opposite case, wherein an anomaly is detected and corrected in the validation step, a first corrected unlabeled data set is generated, which differs from the original unlabeled data set in at least one data record. The first corrected unlabeled data set may be submitted to a second iteration which detects anomalies according to the disclosed method. In the second iteration, the classification method is applied to the first unlabeled corrected data set to generate a second classification model, and anomalies are detected on the basis of the predictions of the second classification model in which case a second corrected data set may be generated as in the first iteration.

In an embodiment described herein, the disclosed method associates a confidence score to the predicted output in step 209. This step is optional. The confidence score is a parameter, or a set of parameters, representative of the reliability or robustness associated to each prediction. Not all the predictions may have the same level of reliability. For instance, a predicted output value that finds a basis on a multiplicity of unambiguous training data records, that is all assigning univocally the same output class, may have a reliability which is greater than a predicted output value based on one training data record, or based on a multiplicity of ambiguous data records, assigning different output classes to identical or similar training data records. The confidence score may in general depend on the classification method and on the classification model generated therefrom. Moreover, in the case of a specific classification method and classification model, different algorithms may be implemented to generate the confidence score. The confidence score associated to a predicted output class may therefore assume different values, according to the specific classification method, classification model and algorithm implemented. The confidence score may assume a value comprised in a finite range defined by a first value and a second value, and the range again depends on the specific classification method, classification model and algorithm used.

Considering a specific classification method, classification model and algorithm for generating the confidence score, a greater value of the confidence typically corresponds to a higher reliability of the prediction. Usually, the first (minimum) value corresponds to a prediction which is considered totally unreliable, while the second (maximum) value corresponds to a prediction which is considered fully reliable. It is possible to implement algorithms that define a confidence score assuming a minimum value when the prediction is considered fully reliable, and a maximum value when the prediction is considered totally unreliable. In the following of the present specification, guidelines and examples for generating a confidence score when using different classification methods are given. Taking into account the complexity of the algorithms and the total number of data records typically involved in real applications, which may easily exceed many thousands of data records, the confidence score may be generated by a computing device.

Once the confidence score and its use are disclosed, and with the support of the following examples, a person skilled in the art may easily define different algorithms to implement the disclosed method according to aspects described herein.

The confidence score is used to trigger the anomaly detection of the training data record. A threshold of the confidence score is fixed, and a discrepancy between the predicted output class and the original output class is detected as an anomaly on the basis of the confidence score assigned to the predicted output value. If the maximum value of the confidence score corresponds to a prediction which is considered fully reliable, this may be the case when the confidence score is less than, or less or equal to, the threshold value. If the maximum value of the confidence score corresponds to a prediction which is considered totally unreliable, this may be the case when the confidence score is greater than, or greater or equal to, the threshold value. In other words, a discrepancy between the predicted output class and the original output class may be a condition to detect an anomaly, but it may not be sufficient, and only if the predicted output is considered sufficiently reliable an anomalous data record is detected.

By changing the value of the threshold of the confidence score, it is possible to tune the sensitivity of anomaly detection thereby reaching a tradeoff between false positive cases (too many fake anomalies detected) and false negative cases (true anomalies not detected). Furthermore, it may be possible to adjust the threshold of the confidence parameter in order to detect a total number of anomalies in a certain range.

In another embodiment described herein, the classification method or the classification model associates a predicted output class to the training data record on the basis of a probability score in step 208. This step is optional. Therefore, for each training data record, the classification method assigns a probability score to each output class of the set of possible output classes, and the predicted output class is the output class which optimizes the probability score. In the simplest formulation, the probability score corresponds to the probability that is it ranges from 0 to 1, and the sum of all the probability scores amounts to 1. A probability of I associated to an output class corresponds to the most reliable prediction that the classification model can provide. In the case of a probability as probability score, the predicted output class of a data record is the output class having the maximum probability. If a tie occurs, the class associated to more samples in the training set may be used. If we have a tie also from this point of view, it is split according to the alphabetical ordering. When alternative algorithms are used, the probability scores may not be normalized to 1, but nevertheless may be transformed into the aforementioned probability.

Also the confidence score of the predicted output class may be assigned on the basis of the probability scores associated to the output classes. Therefore, as an example, an algorithm implementing the confidence score may be proportional to the probability score of the predicted output class, and/or to a measure of the gap between the probability score of the predicted output class and the second highest probability score. The confidence score may also depend on the number of training data records on which the prediction is based.

### Implementation of Classification Methods

1. Standard Classification Problem

In standard classification problems points x in a multidimensional space are to be associated with one of q possible classes. In particular, if d is the dimension of the domain D of x, its components xⱼ, with j=1 . . . . , d, can have one of the following two types:
ordered: when xⱼ varies within an interval Bⱼ of the real axis and an ordering relationship exists between its values;
nominal (or categorical): when the set Aⱼ of values assumed by xⱼ have no natural ordering, e.g. the employment of a customer or the ZIP code.

Several types of variables that can be encountered in practical applications, such as integer or continuous attributes, dates, times or ordinal attributes, can be mapped into ordered variables, with possible changes in the definition of distance and/or of the operators that can act on them.

Any function g: D→{0, . . . , q−1}, called classifier, provides a possible output class y=g(x) in correspondence of any input pattern x∈D. Generally, the classification of a point x is not deterministic, but a probability P(x,y) can be defined, which provides a measure of the likelihood of assigning the class y∈{0, . . . , q−1} to the pattern x. Then, solving a standard classification problem consists in finding the optimal classifier g* that provides the most probable output class y*=g*(x) in correspondence of any input pattern x∈D, e.g., the class y* that maximizes the probability P(x,y) when y∈{0, . . . , q−1}.

In most cases it is supposed that no a priori knowledge about the function g* is available, but its behavior must be retrieved only by analyzing a collection of i observations S={(xᵢ, yᵢ}, i=1, . . . n), called training data set, wherein an observation is a training data record. It follows that any classification method aims at constructing a classifier ĝ, e.g., a classification model, that approximates g* in some way, just by looking at the pairs included in S. A common way of achieving this result consists in minimizing the empirical error cₑₘₚ on the training set S, given by:

$${ϵ}_{emp} = \frac{1}{n} {\sum }_{i = 1}^{n} ( {y}_{i} - g ( {x}_{i} ) )$$

2. Classification Methods Based on Boolean Functions Synthesis

2.1 Description of the Classification Method

Classification methods based on Boolean functions synthesis may be used according to aspects described herein. They are also known as Logic Learning Machine (LLM).

Classification methods based on Boolean functions synthesis map the training data set S into binary strings of a Boolean space, thus obtaining the partial truth table of a Boolean function, which is then reconstructed to derive a set of conditional rules for the classification model g that solves the original classification problem.

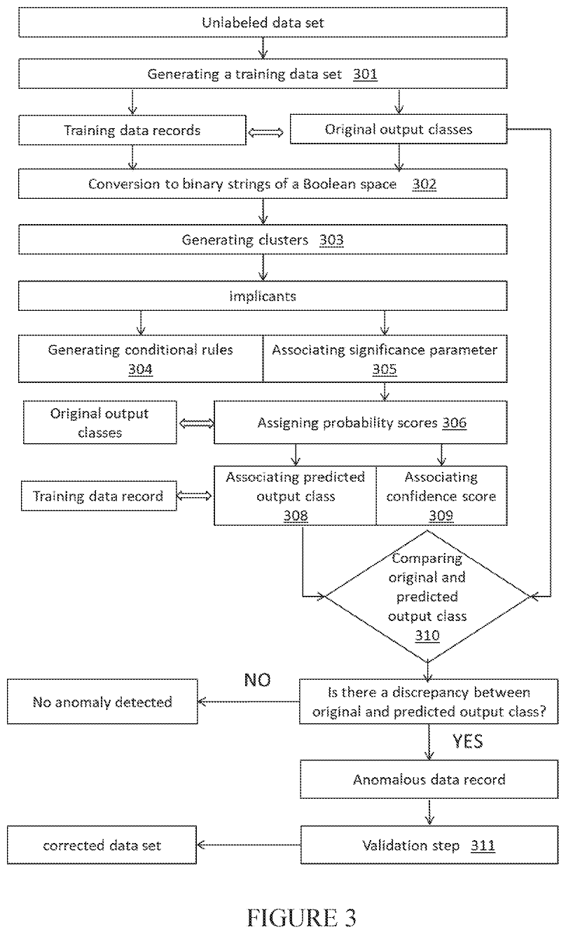

For sake of simplicity, consider the two-class case q=2, where the output y can assume the value 0 or 1; more complex situations for q>2 can be reduced to a sequence of two-class problems. The general procedure adopted by methods on Boolean function synthesis is represented in FIG. 3 and comprises a step 301, wherein the training data set comprising training data records and original output classes is generated from the unlabeled data set.

Then, in step 302, the training data records are converted into binary strings of a Boolean space, by a coding that preserves ordering and distance. As known in the art, a coding mapping a space A into a space B preserves ordering and distance if, given two elements x, y in A, their ordering relationship (x=y, x<y or x>y) and their distance is preserved after mapping them in B. The conversion into binary strings may comprise the following steps:

a. Discretization: Ordered variables xⱼ are discretized by choosing a proper set of cutoffs; as a result, each (ordered or nominal) xⱼ can be transformed into a positive integer variable uⱼ and the original domain D of the classification problem can be mapped on a subset K of the d-dimensional space of positive integer numbers.

For every ordered variable xⱼ it is determined a finite set of bⱼ−1 cutoffs βⱼₗ, with l=1, . . . , bⱼ−1, such that the function g assumes a constant value on every interval (−∞,βⱼ₁], (βⱼ₂,βⱼ₃], . . . , (β_{j,b}_{ⱼ}₋₁, +∞). Thus, an integer variable uⱼ can be defined in the following way:

$${u}_{j} = \{ \begin{matrix}1 & if {x}_{j} ∈ ( - ∞ , {β}_{j 1} ] \\ 2 & if {x}_{j} ∈ ( {β}_{j 1} , {β}_{j 2} ] \\ & ⋮ \\ {b}_{j} & if {x}_{j} ∈ ( {β}_{{jb}_{j} - 1 ,} + ∞ ]\end{matrix} \qquad ( 1 )$$

If integer variables uⱼ∈{1,2, . . . bⱼ} are also used to map the bⱼ values of nominal variables xⱼ, the training set S is transformed into a collection U of n pairs (uᵢ,yᵢ), with i=1, . . . n, being uᵢ a vector of d integers. Although cutoffs βⱼₗ can be chosen in a smart way according to a proper discretization algorithm in order to reduce the complexity of the classification problem at hand while maintaining the information included in the training set S, it is also possible to consider as possible cutoffs all the distinct values (apart from the last one) assumed by the variable xⱼ in S.

b. Binarization: Through the proper coding preserving ordering and distance, each transformed integer variable uⱼ is mapped into a binary string zⱼ; then, by concatenating the d binary strings obtained in this way, the original training set S gives rise to two collections T and F of binary strings z, wherein z∈T if it derives from a pair (xᵢ,yᵢ)∈S with yᵢ=1, and wherein z∈F if it derives from a pair (xᵢ,yᵢ)∈S with yᵢ=0).

In the binarization phase the b; values of integer variables U are coded into binary strings zᵢ of length bⱼ through a coding that preserves ordering and distance. An illustrative coding is the inverse only-one coding that associates with uⱼ=k the binary string having all the bits set to 1 apart from the kth bit which is 0. Through the inverse only-one coding it is also possible to treat in a natural way missing value possibly included in the training set: in this case, a binary string with no 0 values is adopted as mapping.

Once all the integer variables uⱼ have been coded, the whole vector u is associated with the binary string z with length b=Σbⱼ, obtained by concatenating the strings zⱼ derived by transforming the components uⱼ. In this way the original training set S gives rise to two collections T and F of binary strings z with length b: in T are included the binary vectors derived (through U) from the pairs (xᵢ,yᵢ)∈S with yᵢ=1, whereas in F strings corresponding to patterns in S with yᵢ=0 are inserted.

Therefore, the use of binary code typical of a computing device is intrinsic in Logic Learning Machine.

The method further comprises a step 303 of generating one or more clusters of binary strings, wherein the binary strings in a cluster are associated to the same output class. Each cluster is identified or represented by an implicant, which covers all the binary strings of the cluster.

In step 303, binary strings that belong to the same output class and are close to each other according to a proper definition of distance are grouped together. A basic concept in the procedure is the notion of cluster. A cluster is the collection of all the binary strings having the value 1 in a fixed subset of components; as an example, the eight binary strings ‘01001’, ‘01011’, ‘01101’, ‘11001’, ‘01111’, ‘11011’, ‘11101’, ‘11111’ form a cluster since all of them only have the value 1 in the second and in the fifth component.

The sets T and F are viewed as a portion of the truth table of a positive Boolean function ƒ(z), which is then reconstructed by using a proper reconstruction algorithm that produces a set C of binary strings, called implicants. From C the Disjunctive Normal Form (DNF) of ƒ(z) is readily obtained.

Suppose that the sets T and F generated by the binarization phase are disjoint, that is they share no common elements (T∩F=Ø); if this is not the case, the elements belonging both to T and F are to be removed from Tor from F to ensure the fulfillment of the hypothesis, therefore, in place of T and F the sets T′=T\F and F′=F\T are considered. Due to properties of the inverse only-one coding, the sets T and F can be viewed as a portion of the truth table of a positive Boolean function ƒ(z), which can be simply written in its Disjunctive Normal Form (DNF) as a logical sum (OR) of logical products (AND) among some of the b components of string z. The complement operator (NOT) is not involved in the DNF expression of ƒ(z).

Thus, any algorithm for synthesizing a partially defined positive Boolean function (pdpBf) can be used to reconstruct a consistent ƒ(z) from T and F. e.g., a function ƒ(z) such that:

$$f ( z ) = \{ \begin{matrix}1 & if z ∈ T \\ 0 & if z ∈ F\end{matrix}$$

In fact, since the application of the inverse only-one coding produces only binary strings having length b and including d bits with value 0, if T and F contain only a very small subset of the total possible

$$( \begin{matrix}b \\ d\end{matrix} )$$

strings of this kind, several consistent positive Boolean functions ƒ(z) exist that verify the partial truth table determined by T and F. It follows that the method employed for positive Boolean function synthesis must adopt a proper induction principle for determining which of the consistent functions ƒ(z) leads to the classifier ĝ that best approximates the optimal g*. An illustrative technique of this kind is Shadow Clustering (SC), which will be described in the following section.

The notion of covering between binary strings is central in positive Boolean function synthesis: given two strings z, w∈{0,1}^{b} we say that z covers w (in symbols z≤w) if zₖ≤xₖ for every k=1, . . . , b. At the end of its construction, SC (as any other method for synthesizing a pdpBf) generates a collection C of m binary strings in {0,1}^{v}, which are called implicants. The resulting positive Boolean function ƒ(z) assumes value 1 for all and only the strings z covered by one of the implicants in C.

These strings can be easily retrieved by observing that the value 0 inside implicants plays the role of a don't care symbol: by substituting the value 1 in every place where a 0 is present, all the binary strings z covered by each implicant is found. From the set C the DNF of the resulting positive Boolean function ƒ(z) can be readily derived, by writing the logical sum of m logical products, each one obtained from a different implicant in C, using as operands the components of z associated with the bits having value 1 in the implicant. The logical product derived by an implicant in this way assumes value 1 only in correspondence of binary strings z covered by that implicant. As a consequence, the DNF assumes value 1 for all the strings z covered by some implicant in C.

Therefore, in step 303 it is generated at least one cluster of binary strings, the cluster comprising binary strings covered by an implicant, wherein the corresponding training data records are associated to the same output class.

The disclosed method further comprises a step 304, wherein each implicant in C may be directly transformed into a conditional rule concerning the classification problem at hand, thus producing the desired model k that approximates the optimal g*. Because the Boolean function is positive, the logical operators linking different conditions of the conditional rule may be AND and/or OR.

After the application of the inverse only-one coding in the binarization phase, every bit included in the binary string zⱼ associated with an ordered variable xⱼ is associated with an interval in the domain of xⱼ. Similarly, every bit in the string zⱼ derived by a nominal variable xⱼ corresponds to a possible value assumed by xⱼ. This property makes it possible to directly transform any implicant in C into an intelligible rule concerning the classification problem at hand. It is sufficient to consider the substrings wⱼ of the implicants w∈C associated with the variables xⱼ; and derive from them a set of conditions (linked through the AND operator) to be used in the premise of the corresponding rule.

Three different situations can be encountered:
1. The substring wⱼ includes only values 0; in this case all the possible binary substrings zⱼ are covered by wⱼ and therefore no condition on the associated variable xⱼ has to be included in the premise of the resulting rule.
2. The associated variable xⱼ is nominal; then, each bit of the substring wⱼ corresponds to a particular value assumed by xⱼ. Since only coding strings zⱼ having a value 0 in one of the positions where wⱼ has also a 0 are covered by wⱼ, the associated membership condition is xⱼ∈Bⱼ, where Bⱼ is the subset of nominal values for which a value 0 in wⱼ is present.
3. The associated variable xⱼ is ordered; in this case, the execution of SC always produces implicants w with a substring wⱼ including a single run of 0s, e.g., a single sequence of consecutive bits with value 0. It can be easily seen that only coding strings zⱼ having a value 0 in one of the positions of this run are covered by wⱼ. Since each bit in wⱼ is associated with an interval in the domain of xⱼ, it is straightforward to derive the whole interval (λ,μ] corresponding to the run of 0s. The resulting threshold condition on xⱼ to be included in the premise part of the resulting rule is then λ<xⱼ≤μ, which can become xⱼ≤μ (resp. xⱼ>λ) if the run of 0s includes the first (resp. last) bit of the substring wⱼ.

In methods based on Boolean functions synthesis, the classification model comprises the conditional rules defined in step 304. The conditional rules are intelligible rules which may be interpreted by a human operator. Therefore, in the case that the validation step is performed by or under the supervision of a human operator, the validation step may occur on the basis of the conditional rules verified by the anomalous data record.

A further advantage of the use of classification methods based on Boolean functions synthesis, in particular of using a Shadow Clustering technique, is that the set of conditional rules may comprise overlapping rules, that is a data record may satisfy more than one rule. It may also satisfy two conflicting rules, wherein a training data record satisfies two conditional rules associating the training data record to two different output classes. This allows to take into account multiple patterns of functional dependency at the same time for the same record, while the use of decision trees forces to rely, progressively, on the most significant discriminating threshold for each input attribute, in turn.

Significance parameters may be assigned to each conditional rule in step 305, wherein the significance parameters express the importance or strength of the rule. For instance, a rule which originates from a large number of training record, may be more significant than a rule originating from a few training records. Two illustrative significance parameters covering C and error E may be defined as follow.

Considering a classification model comprising a set R of n rules r₁, . . . rₙ, wherein the rule rᵢ has one among N possible outputs ŷᵢ. The number of patterns belonging to output class l is denoted as Nₗ.

The rule rᵢ has mᵢ conditions cᵢ₁, . . . cᵢₘ_{ᵢ}.

Any condition cᵢⱼ defines a domain Dᵢⱼ in the input space, which can be either a set of values for nominal attributes or an interval for ordered attributes.

The rule rᵢ has covering C(rᵢ), and error E(rᵢ). C(rᵢ) is defined as the ratio of training data records with the output predicted by r, which fulfill the hypotheses (or conditions) of rᵢ; E(rᵢ) is defined as the ratio of training data records with any output except the one predicted by rᵢ which fulfill the hypotheses of rᵢ.

A probability score may be assigned in step 306 to each output class on the basis of the significance parameters of the rules satisfied by the training data record. As an example, the following illustrative procedure may be followed:

Let x={x₁, . . . , x_{d}} be a training data record and let Hᵢ(x)={rᵢ|xⱼ∈Dᵢⱼ for each j and ŷᵢ=l} be the set of rules satisfied by x. A probability score wₗ may be associated to each output class according to the following formula:

$${w}_{l} = {N}_{l} ( 1 - {\prod }_{r ∈ {H}_{l}} ( 1 - C ( r ) ( 1 - E ( r ) ) )$$

By observing the formula, we can notice that the probability score of the I class is maximum (and equal to Nₗ) for a pattern if Π_{r∈H}_{ₗ}(1−C(r)(1−E(r)) is equal to 0. The product itself, in turn, depends on the covering and error of the verified rules. More specifically, if a perfect rule (C(r)=1, E(r)=0) were verified, the score would be equal to N_{ƒ}, it increases with covering and decreases with error.

A probability for each output class l is given by wₗ/Σᵢ₌₁^{N}wₗ.

In step 308, a predicted output class is associated to each training data record by the set of conditional rules.

For instance, the predicted output class may correspond to the output class with the highest probability score.

A confidence score in then associated to the predicted output class in step 309. An exemplary confidence score may be defined for instance as wₗ_{₁}−wₗ_{₂}, where wₗ_{₁} is the highest score and wₗ_{₂} is the second highest score.

The original output class and the predicted output class are therefore compared in step 310 and an anomalous data record is detected in a presence of a discrepancy between the original output class and the predicted output class.

Once an anomaly has been detected, the anomalous data record may be then submitted to a validation step 311. The validation step 311 may confirm the original data record, or it may correct the original data record with the predicted output class, or the original data record may be rejected and excluded from the original data set. As a result of the validation step 311, a corrected data set may be generated.

### Shadow Clustering Algorithm

Starting from two disjoint sets T and F of binary strings with length b, the purpose of a method for reconstructing positive Boolean functions is to generate a collection C of implicants such that for each z∈T there is at least one w e C that covers z (e.g., w≤z) and for each z∈F there is now∈C that covers z. This target can be reached if T does not include a string v that covers some z∈F. If this is not the case, conflicting elements are to be removed from T or from F to ensure the fulfillment of the hypothesis. As described in the previous section, it is then immediate to write down from C the DNF expression of the resulting positive Boolean function ƒ(z), which assumes value 1 in correspondence of all the binary strings z e T and value 0 for all z∈F.

Since in general the sets T and F contains only a small portion of the truth table of ƒ(z), several consistent DNF expressions for ƒ(z) can be found and an induction principle has to be defined in order to achieve the optimal positive Boolean function ƒ(z) that corresponds to the classifier ĝ(x) that best approximates the optimal g*(x). A possible choice amounts to considering the Occam's Razor principle, according to which the simplest DNF expression (in terms of number of logical products and of operands inside them) has to be searched for. Other choices involve a proper measure that evaluates the quality of resulting implicants.

In fact, if n_{T}=|T| (resp. n_{F}=|F|) is the number of elements in the set T (resp. F), for any binary string w we can define four quantities:
the number TP(w) (true positive) of elements in T that are covered by w;
the number FP(w) (false positive) of elements in F that are covered by w;
the number FN(w)=n_{T} −TP(w) (false negative) of elements in T that are not covered by w;
the number TN(w)=n_{F} −FP(w) (true negative) of elements in F that are not covered by w.

Starting from these four quantities, several quality measures can be defined; a good choice is the novelty N(w) having the following form:

$$N ( w ) = \frac{T P ( w )}{n} - \frac{T P ( w ) + F N ( w )}{n} \cdot \frac{TP ( w ) + FP ( w )}{n} \qquad ( 2 )$$

Once the quality measure Q(w) is selected, finding the collection C of implicants that achieve the maximum of Σ_{w} Q(w) while covering all the elements in T is an NP-complete problem and consequently cannot be efficiently solved by any algorithm. A near-optimal solution can be found through the Shadow Clustering (SC) algorithm that adopts the following iterative approach:

| 1. | Set C = Ø and V = T. | |
|---|---|---|
| 2. | Set w = 00 ... 000 and compute the initial quality measure Qₘₐₓ = | |
| | Q(w). | |
| 3. | Set lₘₐₓ = 0. For every l = 1, ..., b such that wₗ = 0 do | |
| | a. | Set wₗ = 1. |
| | b. | Let xⱼ be the variable associated with the substring zⱼ |
| | | including wₗ. If zⱼ includes only bits with value 1 or if xⱼ |
| | | is an ordered variable and there are two runs of 0s in the |
| | | substring zⱼ then go to Step 3d. |
| | c. | If Q(w) > Qₘₐₓ then set Qₘₐₓ = Q(w) and lₘₐₓ = l. |
| | d. | Set wₗ = 0. |

| | |
|---|---|
| 4. | If lₘₐₓ > 0 then set wₗ_{ₘₐₓ} = 1 and go to Step 3. |
| 5. | Add the implicant w to the set C. Remove from V all the strings z |
| | that are covered by w (e.g., for which w ≤ z). If V is not |
| | empty go to Step 2. |
| 6. | Simplify the set C by merging elements and by removing from it |
| | redundant implicants w whenever possible. |

Initially the collection C is empty and T is copied into the set V that may be iteratively reduced to include the strings z not yet covered by elements in C (Step 1). Then, implicants w to be inserted into C are iteratively constructed by changing the bits with value 0 that maximize a desired quality measure Q(w) (Steps 2-5). In particular, once the lth bit is selected at Step 3 and its value wₗ is changed to 1, at Step 3b the variable xⱼ associated with the substring zⱼ including wₖ is considered. If it does not contain 0 values, e.g., it does not cover any feasible value for xⱼ, or two runs of 0s are present in zⱼ, being xⱼ an ordered variable, then the bit wₗ is reset to zero and another index is taken into account.

At Step 3c the index lₘₐₓ leading to the maximum value Qₘₐₓ for Q(w) is determined. If such an index cannot be found current implicant w is added to C, since changing further bits with value 0 does not increase quality measure Q(w). Then, the strings z∈V that are covered by w are removed from V (Step 5) and Steps 2-5 are repeated for generating new near optimal implicants to be added to C, if V is not empty.

Finally, at Step 6 elements in C that can be merged are treated and possibly redundant implicants w (covering only strings in T already covered by other elements of C) are removed from C, thus simplifying the resulting positive Boolean functions ƒ(z).

### 2.3 Example

Consider an illustrative unlabeled data set of two input variables, x₁ and x₂, and one output variable, y, as represented in Table 1. We assume that the variable x₁ denotes the set size for the items to be produced and that the variable x₂ denotes a production mode. According to these two features, it is assumed that the supply chain determines how to procure the raw materials for production: internally or externally. A variable y stores this information and it can assume the value “internal” or “external”. As described, the output variable y depends on x₁ and x₂. Variable x₁ is numerical and variables x₂ and y are categorical.

TABLE 1
illustrative unlabeled data set

| x₁ | x₂ | y |
|---|---|---|
| 10 | a | internal |
| 15 | a | internal |
| 20 | b | external |
| 20 | b | internal |
| 25 | b | external |
| 30 | b | external |
| 40 | a | internal |
| 50 | a | internal |

The training data records comprises variables x₁ and x₂, and they are associated to output classes corresponding to variable y.

The first step is the discretization of the variables. Discretization comprises transforming quantitative attributes, which can assume an infinite number of values, into discrete attributes, subdividing the set of possible values assumed by them into a number of intervals. Each of the intervals is associated with an integer value, so a quantitative attribute uⱼ is defined as follows:

$${u}_{j} = \{ \begin{matrix}1 & if {x}_{j} ∈ ( - ∞ , {β}_{j 1} ] \\ & … \\ {b}_{j} & if {x}_{j} ∈ ( {β}_{{jb}_{j} - 1} , ∞ )\end{matrix}$$

Note that it may be necessary to choose the number of intervals b, and the thresholds βₖ, with k=1, . . . , bⱼ₋₁, of each interval. The output value of each observation is considered, by trying to create intervals in such a way that, for two observations with different output class there is at least one attribute for which the two observations fall into different ranges. In other words, the aim is not to create ambiguities. It follows that:

$${u}_{1} = \{ \begin{matrix}1 & if {x}_{1} < 17 \\ 2 & if 17 < {x}_{1} \leq 22 \\ 3 & if 22 < {x}_{1} \leq 35 \\ 4 & if {x}_{1} > 35\end{matrix}$$

Also nominal attributes are transformed in this phase, for instance the attribute u₂ associated with x₂ is defined as:

$${u}_{2} = \{ \begin{matrix}1 & if {x}_{2} ∈ \{ a \} \\ 2 & if {x}_{2} ∈ \{ b \}\end{matrix}$$

Finally, output classes are redefined as 0 (internal) and 1 (external), so that the training data set with associated output classes after discretization is shown in Table 2.

TABLE 2
training data set after discretization

| u₁ | u₂ | y |
|---|---|---|
| 1 | 1 | 0 |
| 1 | 1 | 0 |
| 2 | 2 | 1 |
| 2 | 2 | 0 |
| 3 | 2 | 1 |
| 3 | 2 | 1 |
| 4 | 1 | 0 |
| 4 | 1 | 0 |

In the binarization phase, the discretized training data set is turned into a Boolean domain: each integer value assumed by the generic uⱼ attribute is substituted with a binary string. More specifically, each attribute uⱼ is encoded by the inverse only-one coding, by creating a string hⱼ, which consists of bⱼ bits, with value 1, except for the bit corresponding to the value assumed by uⱼ.

For instance, u₁=3 is associated with the string h₁=1101. Each input vector u is then represented with a string of bits z, derived from the chaining of strings hⱼ. This resulting string z may be composed by elements z; with j=1, . . . , b, where b=Σⱼbⱼ, and the new training set has input values in {0, 1}^{b} and output values in {0, 1}.

This training set can be divided into two subsets T and F containing the strings z associated with the output class y=1 and y=0, respectively:
T={101110,110110,110110}
F={011101,011101,101110,111001,111001}

The training data dataset and corresponding output classes obtained after binarization is reported in Table 3:

TABLE 3
training data set after binarization

| z | y |
|---|---|
| 011101 | 0 |
| 011101 | 0 |
| 101110 | 1 |
| 101110 | 0 |
| 110110 | 1 |
| 110110 | 1 |
| 111001 | 0 |
| 111001 | 0 |

The next step is to reconstruct the positive Boolean function by the Shadow Clustering algorithm from the binarized training data set, to define a set of implicants each covering clusters of binary strings.

As the sets T and F generated by the binarization phase are not disjoint (in fact, T∩F≠Ø), we define the sets T′=T\F and F′=F\T and then consider the two couple of sets:
T′={110110,110110}
F={011101,011101,101110,111001,111001}
T={101110,110110,110110}
F′={011101, 011101, 111001, 111001}

The application of the Shadow Clustering algorithm produces for T the implicant:
v₁=000010

and, for F, the implicants:
v₂=000001
v₃=001110

Consider the problem defined by Table 3 and suppose that implicants for subset F have to be constructed. To this aim, the sets F′ and Tare considered. Let us employ only the novelty as a quality measure and let us consider the case a=1, corresponding to novelty defined in equation (2). According to the Shadow Clustering procedure (see the corresponding paragraph), the implicant is initialized to 000000. The 000000 implicant covers all the Boolean strings, both in F′ and in T, therefore TP=4, FP=3, FN=TN=0 and, according to equation (2), N(v)=0.

Then the iteration described in step 3 of the Shadow Clustering procedure is started. Each bit is switched to 1 and the quality measure of the obtained implicant is computed. The results are reported in Table 4:

TABLE 4
Shadow Clustering, first iteration

| Implicant | Valid? | TP | FP | FN | TN | N(v) |
|---|---|---|---|---|---|---|
| 100000 | Yes | 2 | 3 | n | 0 | −0.122 |
| 010000 | No | | | | | |
| 001000 | No | | | | | |
| 000100 | Yes | 2 | 3 | 2 | 0 | −0.122 |
| 000010 | Yes | 0 | 3 | 4 | 0 | −0.245 |
| 000001 | Yes | 4 | 0 | 0 | 3 | 0.245 |

Notice that, since the substring of an implicant associated with an input variable should include only a run of 0s, not all the potential implicants are valid. In particular implicants 010000 and 0010000 are not valid since each of them includes two runs of 0s in the part of the implicant associated with x₁ and therefore is not considered at Step 3b of the Shadow Clustering procedure. According to Table 4, the implicant with the highest quality measure is 000001 and is therefore selected at Step 4 of the Shadow Clustering procedure. After this first iteration the built implicant does not generate false positive and therefore no other bits should be switched to 1. As a matter of fact, as Table 5 shows, the quality measures associated with the new potential implicants at a new iteration is lower than the quality measure of the starting implicant (000001) and therefore, according to Step 3c of Shadow Clustering, no bit is switched to 1 and the iteration at Step 3 stops.

TABLE 5
Shadow Clustering, second iteration

| Implicant | Valid? | TP | FP | FN | TN | N(v) |
|---|---|---|---|---|---|---|
| 100001 | Yes | 2 | 0 | 2 | 3 | 0.12244898 |
| 010001 | No | | | | | |
| 001001 | No | | | | | |
| 000101 | Yes | 2 | 0 | 2 | 3 | 0.12244898 |
| 000011 | No | | | | | |

Notice that the implicant 000011 is not valid since it contains only 1s in the part associated with x₂ (see point 3b of the Shadow Clustering procedure). Through this procedure, we derived the v₂ implicant. Similarly, also v₁ and v₃ are derived by Shadow Clustering.

From the implicants, taking into account the ranges of the discretized variables corresponding to bits having value 1, it is possible to generate the following conditional rules:
from v₁, the conditional rule r₁: IF x₂∈{b} THEN y=external
from v₂, the conditional rule r₂: IF x₂∈{a} THEN y=internal
from v₃, the conditional rule r₃: IF x₁≤22 THEN y=internal

Referring to the three rules extracted in the example, their covering and error are the following:
C(r₁)=3/3=1; E(r₁)=1/5=0.2
C(r₂)=4/5=0.8; E(r₂)=0/3=0
C(r₃)=3/5=0.6; E(r₃)=1/3=0.333

Scoring all the training data records in the training data set except the 3^{rd} and the 4^{th} is trivial: each of them only verifies one rule, predicting “internal” (1^{st}, 2^{nd}, 7^{th} and 8^{th} training data records) or “external” (5^{th} and 6^{th} training data records) output. Concerning the 3^{th} and the 4^{th} training data records (x₁=20, x₂=b), which instead verify the conflicting rules r₁ and r₃, the output scores w₀ and w₁ are computed as follows:

w₀=5{1−[1−0.6(1−0.333)]}=2

w₁=3{1−[1−1.0(1−0.2)]}=2.4

Then, class 1, that is “external” is predicted for the two training data records. This corresponds to suggesting a correction for the 4^{th} training data record, even if there are two identical instances with two different output classes and, consequently the ambiguity cannot be trivially solved by choosing the most frequent output class. The correction is proposed according to the behavior of the other similar training data records in the training data set with respect to the functional dependency (x₁,x₂)→y. In other words, the algorithm suggests “external” for the 4^{th} training data record because, even if the “internal” class is more frequent in the whole training data set, all the other training data records in the training data set with x₁ being in the same range (that is, 17-35) and with the same value of x₂ (that is, b) are associated with that output class. The following Table 6 summarizes the example:

TABLE 6
Summary of the results on the illustrative training data set

| | | | | | w₀ | w₁ | | confi- |
|---|---|---|---|---|---|---|---|---|
| #re- | | | output | | (inter- | (exter- | predicted | dence |
| cord | x₁ | x₂ | class | rule | nal) | nal) | output | score |
| 1 | 10 | a | internal | r₃ | 0.88 | 0 | internal | 0.88 |
| 2 | 15 | a | internal | r₃ | 0.88 | 0 | internal | 0.88 |
| 3 | 20 | b | external | r₁ and | 2 | 2.4 | external | 0.4 |
| | | | | r₃ | | | | |
| 4 | 20 | b | internal | r₁ and | 2 | 2.4 | external | 0.4 |
| | | | | r₃ | | | | |
| 5 | 25 | b | external | r₁ | 0 | 0.8 | external | 0.8 |
| 6 | 30 | b | external | r₁ | 0 | 0.8 | external | 0.8 |
| | 40 | a | internal | r₂ | 0.8 | 0 | internal | 0.8 |
| 8 | 50 | a | internal | r₂ | 0.8 | 0 | internal | 0.8 |

3. Classification Methods Based on Decision Tree

A decision tree is a flowchart-like structure in which each internal node represents a “test” on an attribute (e.g. whether a coin flip comes up heads or tails), each branch represents the outcome of the test, and each leaf node represents a class label (decision taken after computing all attributes). The paths from root to leaf represent classification rules.

Classification methods based on decision tree are described in, for example, Quinlan, J. Ross. C4. 5: programs for machine learning. Elsevier, 2014. The classification model is in the form of disjoint conditional rules, that is each data record satisfy only one rule.

Exemplary parameters used in the disclosed method may be defined as follows. Alternative definitions of the parameters falling within the scope of the invention may be defined as well.

Significance parameters, for instance covering and error, may be defined as in the case of classification methods based on Boolean function synthesis.

Both a confidence and a probability score can be associated to each output class by the same procedure described for Shadow Clustering, applying it on the conditional rules constituting the decision tree. The only difference is that it might not be possible to have more than one output score greater than 0, for each record.

4. Classification Methods Based on SVM

SVM is a classifier based on the identification of an optimal hyperplane of separation between different classes.

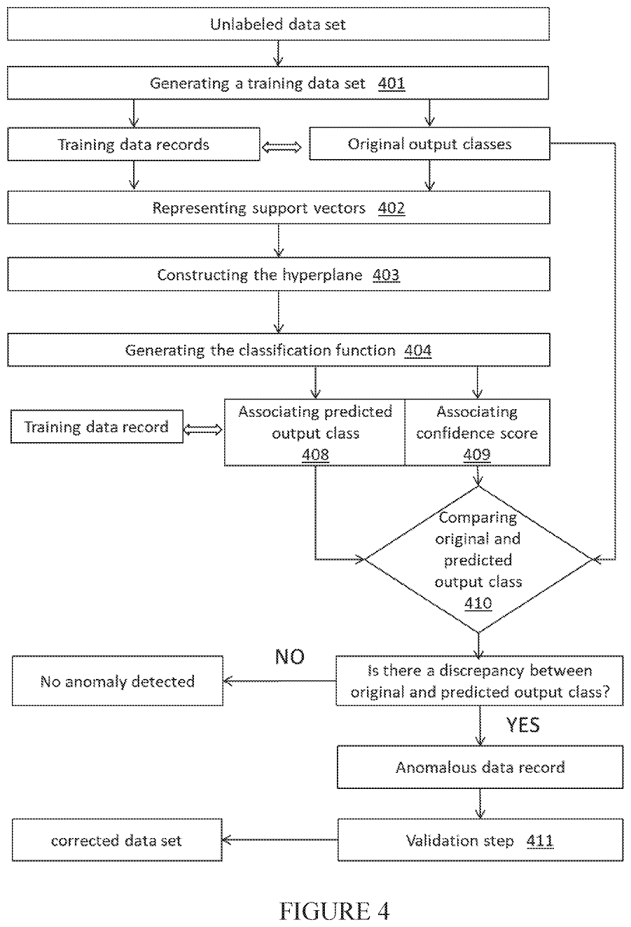

FIG. 4 represents the general procedure adopted by methods based on SVM. A Support Vector Machine constructs a hyperplane or set of hyperplanes in a high- or infinite-dimensional space, which can be used for classification, regression, or other tasks. Intuitively, a good separation can be achieved by the hyperplane (or, more generally, by the geometrical kernel) that has the largest distance to the nearest training-data point of any class (so-called functional margin), since in general the larger the margin the lower the generalization error of the classifier.

Classification methods based on SVM are described in, for example. Byun, Hyeran, and Seong-Whan Lee. “Applications of support vector machines for pattern recognition: A survey.” Pattern recognition with support vector machines. Springer. Berlin, Heidelberg, 2002.

Therefore, the classification model is in the form of a classification function, whose shape allows to distinguish output classes with the biggest possible margin.

FIG. 4 represents the general procedure adopted by methods based on an SVM.

From the unlabeled data set, the training set comprising the training data records (support vectors) and the corresponding original output classes is generated in step 401.

The support vectors are then represented in a projected space defined by the input variables in step 402.

A hyperplane in the projected space is then determined in step 403, wherein the hyperplane divides the projected space into at least two regions, each region corresponding to one output class.

The class y for any input vector x is then given by the following formula, where K(⋅, ⋅) denotes a kernel function used to perform a non-linear classification by constructing an optimal hyperplane in the projected space:

$$y = sgn ( {\sum }_{j = 1}^{l} {y}_{j} {α}_{j} K ( {x}_{j} , x ) + b )$$

Different well-known training algorithms can be applied to compute the coefficients aⱼ and the offset b.

Therefore, the classification model is generated in the form of a classification function in step 404, associating an output class to an input data record.

The classification model is then applied to the training data records, thereby associating the corresponding predicted output class to each training data record in step 408.

The original output class and the predicted output class are therefore compared in step 410 and an anomalous data record is detected in a presence of a discrepancy between the original output class and the predicted output class.

A confidence score may be assigned to each predicted output to trigger the anomalous detection in step 409. The confidence score may be defined as follows. Alternative definitions of the parameters falling within the scope of the invention may be defined as well.

When the Support Vector Machine model is applied to a record, it returns (together with the predicted value for that record) a continuous value, which can be considered a significance parameter for the prediction.

The confidence score represents an approximation of the maximum a posteriori (MAP) probability, so that a score may be associated with each output class based on this value, as shown in Sollich, Peter. “Bayesian methods for support vector machines: Evidence and predictive class probabilities.” Machine learning 46.1-3 (2002).

Once an anomaly has been detected, the anomalous data record may be then submitted to a validation step 411. The validation step 411 may confirm the original data record, or it may correct the original data record with the predicted output class, or the original data record may be rejected and excluded from the original data set. As a result of the validation step 411, a corrected data set may be generated.

5. Classification Methods Based on Neural Networks

Neural networks can be represented as an interconnection of learning layers, each of which is constituted by a linear approximator.

Classification methods based on neural networks are described in, for example, Gurney, Kevin. An introduction to neural networks. CRC press, 2014.

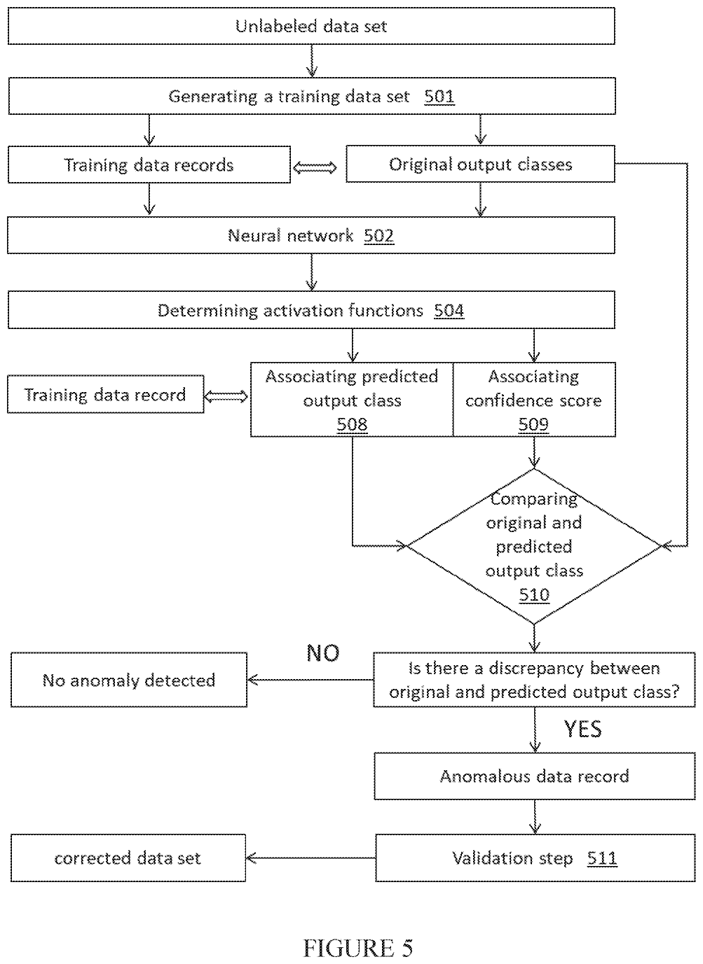

FIG. 5 represents the general procedure adopted by methods based on a neural network.

Neural networks are comprised of a sequence of learning layers, each layer comprising one or more nodes (neurons), wherein each neuron is interconnected with the nodes (e.g., all the nodes) of the previous layer in the sequence of layers (neuron input) and to the nodes (e.g., all the nodes) of the next layer in the sequence of layers (neuron output). Each neuron is characterized by an activation function which is determined by the training procedure of the neural network on the training data set. The neural network comprises at least two layers, such as a first layer which receives the data records at the input and a last layer whose output is associated to an output class.

From the unlabeled data set, the training data set comprising the training data records and the corresponding original output classes is generated in step 501.

Then, the training data set are introduced to a first layer of a neural network in step 502; the activation functions of the nodes of the neural network are then iteratively determined in step 504, wherein the output of the last layer of the neural network is associated to an output class.

The classification model is in the form of the group of the activation functions charactering the neural network and the training data set.

The classification model is then applied to the training data records in step 508, by introducing each training data record to the neural network with the activation function previously defined and determining the corresponding predicted output class.

The original output class and the predicted output class are therefore compared in step 510 and an anomalous data record is detected in a presence of a discrepancy between the original output class and the predicted output class.

A confidence score may be assigned to each predicted output to trigger the anomalous detection in step 509. The confidence score may be defined as follows. Alternative definitions of the parameters falling within the scope of the invention may be defined as well.

When the Neural Network model is applied to a record, it returns (together with the predicted value for that record) a continuous value, which can be considered a significance parameter for the prediction.

The confidence score represents an approximation of the maximum a posteriori (MAP) probability, so that a score may be associated with each output class based on this value, as shown in Richard, Michael D., and Richard P. Uppmann. “Neural network classifiers estimate Bayesian a posteriori probabilities.” Neural computation 3.4 (1991).

Once an anomaly has been detected, the anomalous data record may be then submitted to a validation step 511. The validation step 511 may confirm the original data record, or it may correct the original data record with the predicted output class, or the original data record may be rejected and excluded from the original data set. As a result of the validation step 511, a corrected data set may be generated.

What is claimed is:

1. A computer-implemented method for detecting anomalies in an unlabeled data set, wherein the unlabeled data set comprises data records of input variables and at least one output variable dependent from one or more input variables, said method comprising:
a. from the unlabeled data set, generating, by a computing device, a training data set comprising training data records and original output classes, wherein:
i. each training data record is obtained by excluding from a corresponding data record at least the output variable, and
ii. an original output class corresponding to a value of the output variable of the corresponding data record is associated to the training data record;
b. applying, by the computing device, a classification method to the training data set, to generate a classification model associating a predicted output class to the training data record, wherein the predicted output class is selected from the original output classes associated to the training data records; and
c. comparing, by the computing device, the original output class and the predicted output class, wherein an anomalous data record is detected in a presence of a discrepancy between the original output class and the predicted output class.

2. The method of claim 1, further comprising assigning a confidence score to the predicted output class by the classification model, wherein the anomalous data record is detected based on a threshold of the confidence score.

3. The method of claim 2, wherein the predicted output class is the output class which optimizes a probability score assigned to each output class by the classification model.

4. The method of claim 3, wherein the confidence score of the predicted output class is assigned based on the probability scores associated to the output classes.

5. The method of claim 1, further comprising submitting the anomalous data record to a validation step, to generate a corrected data set.

6. The method of claim 1, wherein the classification model is in a form of a set of conditional rules of input variables.

7. The method of claim 6, wherein the classification method is based on Boolean functions synthesis, said method comprising:
a. converting the training data records into binary strings of a Boolean space by a coding that preserves ordering and distance;
b. generating at least one cluster, the cluster comprising binary strings covered by an implicant, wherein the corresponding training data records are associated to the same output class; and
c. from the implicant, generating a conditional rule.

8. The method of claim 7, wherein the coding is inverse only-one coding.

9. The method of claim 7, wherein the implicant is generated by a Shadow Clustering algorithm.

10. The method of claim 7, further comprising assigning one or more significance parameters to each conditional rule, wherein probability scores are assigned based on the significance parameters of the conditional rules satisfied by the training data record.

11. The method of claim 7, wherein a validation step of the anomalous data record is performed by or under supervision of a human operator based on the conditional rules verified by the anomalous data record.

12. The method of claim 1, wherein the input variables are related to at least one category selected from the group comprising names, codes, time values, address components, control parameters, and numeric values.

13. The method of claim 1, wherein the data records of the unlabeled data set are related to an application selected from the group comprising: auto insurance damage claims, a business process, a medical patient records, a purchase order, and a supply chain management.

14. The method of claim 1, wherein the method is integrated in a business or operations software application selected from the group comprising: enterprise resource planning (ERP), customer relationship management (CRM), product lifecycle management (PLM), and electronic health records management (EHRM).

15. An apparatus comprising:
a processor; and
memory storing computer-executable instructions that, when executed by the processor, cause the apparatus to:
from an unlabeled data set comprising data records of input variables and at least one output variable dependent from one or more input variables, generate a training data set comprising training data records and original output classes, wherein:
each training data record is obtained by excluding from a corresponding data record at least the output variable, and
an original output class corresponding to a value of the output variable of the corresponding data record is associated to the training data record;
apply a classification method to the training data set, to generate a classification model associating a predicted output class to the training data record, wherein the predicted output class is selected from the original output classes associated to the training data records; and
compare the original output class and the predicted output class, wherein an anomalous data record is detected in a presence of a discrepancy between the original output class and the predicted output class.

16. The apparatus of claim 15, wherein the computer-readable instructions, when executed by the processor, further cause the apparatus to:
assign a confidence score to the predicted output class by the classification model, wherein the anomalous data record is detected based on a threshold of the confidence score.

17. The apparatus of claim 16, wherein the predicted output class is the output class which optimizes a probability score assigned to each output class by the classification model.

18. The apparatus of claim 17, wherein the confidence score of the predicted output class is assigned based on the probability scores associated to the output classes.

19. The apparatus of claim 15, wherein the computer-readable instructions, when executed by the apparatus, cause the apparatus to:
submit the anomalous data record to a validation step, to generate a corrected data set.

20. The apparatus of claim 15, wherein the classification model is in a form of a set of conditional rules of input variables.
